(19) United States
(12) Patent Application Publication
(10) Pub. No.: US 2022/0242512 A1
(43) Pub. Date: Aug. 4, 2022

(54) MOTORCYCLE FAIRING AND DASH COVER

(71) Applicant: John Olgin, Midland, TX (US)

(72) Inventor: John Olgin, Midland, TX (US)

(21) Appl. No.: 17/230,033

(22) Filed: Apr. 14, 2021

Related U.S. Application Data
(60) Provisional application No. 63/145,713, filed on Feb. 4, 2021.

(51) Int. Cl. B62J 19/00; B62H 5/00; B62H 5/20

(52) U.S. Cl. CPC B62J 19/00; B62H 5/20; B62H 5/001

(57) ABSTRACT

This present invention relates to a weatherproof and stretchable cover for a portion of a motorcycle. One variant of the cover protects both the fairing and dashboard of the motorcycle. The cover has an elastic band positioned along the periphery of an opening in the cover to form a front surface which encloses the front fairing and dashboard along with turning lights and headlamp when the elastic band is stretched. The elastic band securely attaches to the edges of the fairing and dashboard for a secure and tight fit. An exterior surface of the cover may have any logo or trademark for advertising purpose, and the cover prevents the portion of the motorcycle covered thereby from exposure to harmful UV rays, inclement weather and tampering.

### CROSS-REFERENCE TO RELATED APPLICATION

The present application claims priority to, and the benefit of, U.S. Provisional Application No. 63/145,713, which was filed on Feb. 4, 2021 and is incorporated herein by reference in its entirety.

### FIELD OF THE INVENTION

The present invention relates generally to the field of motorcycle hood covers and motorbike fairing covers. More specifically, the present invention relates to a motorcycle fairing and dash cover which prevents damage from dirt, debris, water, sunlight and other detrimental exposure elements. The motorcycle fairing and dash cover features a weatherproof and stretchable cover or mask with a circumferential elastic edge designed to enclose the fairing, dash and associated components. The cover can be secured around the peripheral sides and edges of the fairing and dash. The motorcycle fairing and dash cover conforms to the shape and contours of the fairing and dash. Additionally, the mask can also provide protection for headlamps and turn signals. The motorcycle fairing and dash cover offers a lightweight, portable and reusable means of protecting the fairing and dashboard for user convenience and increased utility. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, a motorcycle fairing is generally a shell or shield that can be placed over and around a frame of some motorcycles. In some applications, fairings can be mounted toward the front portion of a motorcycle. Many types of motorcycles utilize fairings for particular purposes. For example, racing motorcycles and sport bikes utilize fairings to reduce air drag. Touring motorcycles utilize fairings to protect the rider, frame and engine from airborne hazards, as well as to enhance the rider's experience. Fairings accomplish the aforementioned objectives by manipulating the air flow around the motorcycle and the rider(s). In addition, fairings function to protect the rider from airborne hazards and wind-induced hypothermia. Still further, fairings can protect engine components from damage in the case of an accident. Significant financial investments are oftentimes necessary to purchase and mount stylish and/or functional fairings. Therefore, proper care and maintenance of fairings is important in order to provide continued protection of the motorcycle frame, engine, dashboard and instrument cluster. More specifically, the instrument cluster needs protection from water and other detrimental elements in order to maintain its functionality and visibility to the rider.

When ridden or parked outside, dashboards and instrument clusters of touring motorcycles, racing motorcycles, sports bikes and other similar vehicles are exposed to inclement weather and harmful ultraviolet (UV) rays, and are susceptible to damage due to extreme weather conditions. For example, prolonged exposure to ultraviolet rays can oxidize the motorcycle's paint and finish, and even cause the color to fade. UV rays deteriorate factory finishes on motorcycles including the respective finishes on dashboards and instrument cluster components. Over time, deteriorating and/or fading finishes diminish the value and appearance of the motorcycle. UV rays not only affect the outer surfaces of motorcycles, but can also negatively affect the interior parts and components of the cycle and some of the features of the motorcycle (i.e., the instrument cluster components) may become inoperable due to prolonged exposure to the elements. Individuals periodically clean and polish their motorcycles/vehicles to offset the negative effects from exposure. However, vehicle polishing can be cost prohibitive and is oftentimes time consuming.

Additionally, when motorcycles and other similar vehicles are exposed to inclement weather conditions, such as rain or snow, there is a risk of moisture retention which may damage or negatively affect the electrical equipment gauges, speakers, switches and more (i.e., the instrument cluster). In such scenarios, there would be a need to change the internal parts and components for proper operation of the vehicle. Replacing instrument components is both time consuming and expensive, and unnecessarily increases the operating costs of the vehicle.

Various solutions such as shields, hood covers or the like are currently available in the state of the art. However, such devices are difficult and time consuming to install and may cause damage to the paint and appearance of the motorcycles or other vehicles. Further, people may have to buy multiple covers to accommodate the associated head lamps, dashboards, instrument clusters, and turning lights that are proximal to the front area of the vehicle.

Therefore, there exists a long felt need in the art for an improved fairing and dashboard protection cover for a motorcycle or the like that is quick and easy to install and uninstall. There is also a long felt need in the art for a fairing and dashboard protection cover for a motorcycle that can enclose and protect fairings and dashboards of different sizes and that is washable, reusable and easy to store and transport. Additionally, there is a long felt need in the art for a fairing and dashboard protection cover for a motorcycle that does not cause any damage to the paint or negatively affect the appearance of the motorcycle. Moreover, there is a long felt need in the art for a fairing and dashboard protection cover for a motorcycle that securely fits around the periphery of the hood, conforms to the uniform and non-uniform contours therearound, and includes a decorative layer. Furthermore, there is a long felt need in the art for a fairing and dashboard protection cover for a motorcycle that prevents dirt, debris and the long-term detrimental effects of inclement weather from damaging the vehicle. Finally, there is a long felt need in the art for a fairing and dashboard protection cover for a motorcycle that is relatively inexpensive to manufacture and that is both safe and easy to use.

The subject matter disclosed and claimed herein, in one embodiment thereof, comprises a motorcycle dashboard and instrument cluster cover designed to enclose and protect the motorcycle dashboard and instrument cluster from inclement weather and other dirt and debris. The cover comprises a weatherproof and stretchable fabric having a circumferential edge. The circumferential edge can include an elastic band along its length, wherein the weatherproof and stretchable fabric is adapted to enclose the motorcycle dashboard and instrument cluster in a stretched and mounted position. In the mounted position, the cover conforms to the shape and contours of the motorcycle dashboard and instrument cluster.

In this manner, the novel motorcycle dashboard and instrument cluster cover of the present invention accomplishes all of the forgoing objectives, and provides a relatively safe, easy, convenient and cost-effective solution to protect the fairing and dashboard from dirt, debris, inclement weather, moisture or the like. The motorcycle dashboard and instrument cluster cover of the present invention is also user friendly, inasmuch as it is far less expensive than other heretofore known alternatives, and is both easy to install and uninstall.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a fairing cover designed to enclose and protect the motorcycle fairing, dashboard and instrument cluster. The fairing cover comprises a weatherproof and stretchable fabric having a circumferential mounting edge. The circumferential mounting edge comprises, in one exemplary embodiment, an elastic band therearound wherein the weatherproof and stretchable fabric is adapted to enclose (i.e., cover at least the top and sides of) the motorcycle fairing, dashboard and instrument cluster. In a stretched position, the cover can be secured to the outer perimeter of the dashboard and can conform to the shape and contours of the components comprising the dashboard and instrument cluster.

In a further embodiment of the present invention, a stretchable and decorative mask for a motorcycle dashboard and front fairing is disclosed. The decorative mask comprises a front surface of weatherproof and stretchable fabric, and a circumferential elastic or retention band creating an opening that is smaller in size than the front surface of the mask. The mask or cover can provide a protective barrier for the top and sides of the motorcycle dashboard and front fairing. Mounting the cover comprises securing the retention band around the sides of the dashboard in order to secure the cover to the peripheral edges of the dashboard and the front fairing. The mask prevents dirt, debris, moisture and other detrimental elements from damaging the components integrated with the motorcycle dashboard and instrument cluster.

In yet a further embodiment of the present invention, a method for protecting dash and instrument componentry from harmful UV rays, rain, sleet and snow using a reusable cover or ‘moto’ mask is disclosed. The method preferably comprises the steps of: (a) initially providing a reusable moto mask made up of a weatherproof and stretchable fabric including a peripheral retention band or strap; (b) placing one portion of the peripheral retention strap under the bottom edge, and/or around a side edge, of the front fairing of the motorcycle; (c) stretching another portion of the retention strap around another opposing side edge of the front fairing; and (d) securing the moto mask around the entire periphery of the dashboard and instrument cluster of the motorcycle.

In still a further embodiment, a one piece motorcycle hood and dashboard mask is disclosed and comprises stretchable and/or conformable fabric including a front surface having a peripheral elastic or adjustable retention band. The peripheral elastic or adjustable retention band creates an adjustably sized opening that can enclose any variety of differently shaped motorcycle hoods, fairings and dashboards to protect the same from sunshine, rain and other inclement weather. The mask conforms to the shape and protrusions of the instrument componentry mounted to the dashboard. The mask can also provide protection for the headlamp and turn signals protruding from the dashboard.

The mask or cover of the present invention is stretchable and/or adjustable to fit over fairings and dashboards of various sizes, and the material of the mask or cover can provide a non-slip contact surface when mounted to the fairing. The peripheral elastic band or retention strap ensures a secure and tight fit after installation over the fairing and dashboard, and the adjustable retention band or strap provides a secure mechanism to prevent the fairing cover or mask from coming off inadvertently due to an installation failure. The fabric of the mask or cover can have elastic properties which prevent the distortion of a logo or trademark which can be present on the front surface of the mask or cover.

The mask or cover, in all of the potential embodiments of the present invention, protects the motorbike fairing from dirt, debris, and other long term detrimental elements. Protection from the elements prevents damage and unsightly wear to the motorbike fairing and associated components. The cover, when secured and properly fitted on the fairing and/or dashboard, can be stretched or cinched in place to provide protection while the motorcycle is not in use.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the motorcycle fairing and dash cover of the present invention in accordance with the disclosed architecture, wherein the elastic band is in a relaxed state;

FIG. 2 illustrates a perspective view of one potential embodiment of the motorcycle fairing and dash cover of the present invention in accordance with the disclosed architecture, wherein the elastic band is in a stretched state so as to be installed on a motorcycle;

FIG. 3A illustrates a partial perspective view of a prior art motorcycle having a dashboard and instrument cluster;

FIG. 3B illustrates a perspective view of one potential embodiment of the motorcycle fairing and dash cover of the present invention in accordance with the disclosed architecture, wherein the cover is installed on the motorcycle of FIG. 3A;

FIG. 4 illustrates a perspective view of one potential alternative embodiment of the motorcycle fairing and dash cover of the present invention in accordance with the disclosed architecture;

FIG. 5 illustrates a perspective view of one potential alternative embodiment of the motorcycle fairing and dash cover of the present invention in accordance with the disclosed architecture, wherein the cover is installed on the motorcycle of FIG. 3A and covers the fairing of the motorcycle;

FIG. 6 illustrates a partial perspective view of one potential alternative embodiment of the motorcycle fairing and dash cover of the present invention in accordance with the disclosed architecture; and

FIG. 7 illustrates a perspective view of one potential embodiment of the motorcycle fairing and dash cover of the present invention and a second accessory cover in accordance with the disclosed architecture, wherein the covers are installed on the motorcycle of FIG. 3A.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a motorcycle fairing and dash cover that is relatively quick and easy to install and uninstall, and that can enclose and protect fairings and dashboards of different sizes. There is also a long felt need in the art for a motorcycle fairing and dash cover that is washable, reusable and easy to transport and store when not in use. Additionally, there is a long felt need in the art for a motorcycle fairing and dash cover that does not cause any damage to the paint or negatively affect the appearance of the motorcycle. Moreover, there is a long felt need in the art for a motorcycle fairing and dash cover that securely fits around the periphery of the hood, conforms to the uniform and non-uniform contours therearound, and includes a decorative layer. Furthermore, there is a long felt need in the art for a motorcycle fairing and dash cover that prevents dirt, debris and the long-term detrimental effects of inclement weather from damaging the motorcycle. Finally, there is a long felt need in the art for a motorcycle fairing and dash cover that is relatively inexpensive to manufacture and that is both safe and easy to use.

The present invention, in one exemplary embodiment, comprises a novel motorcycle fairing and dash cover that is designed to both enclose and protect the motorcycle fairing, dashboard and instrument cluster. The cover includes a weatherproof and stretchable fabric having an opening circumscribed by, for example, an elastic band along its length, wherein the weatherproof and stretchable fabric is adapted to enclose the motorcycle fairing, dashboard and instrument cluster in a stretched position. More specifically, the cover may be stretched to expand in size from a first size to a second size. In the second size, the stretched cover conforms substantially to the shape and contours of the motorcycle fairing, dashboard and instrument cluster.

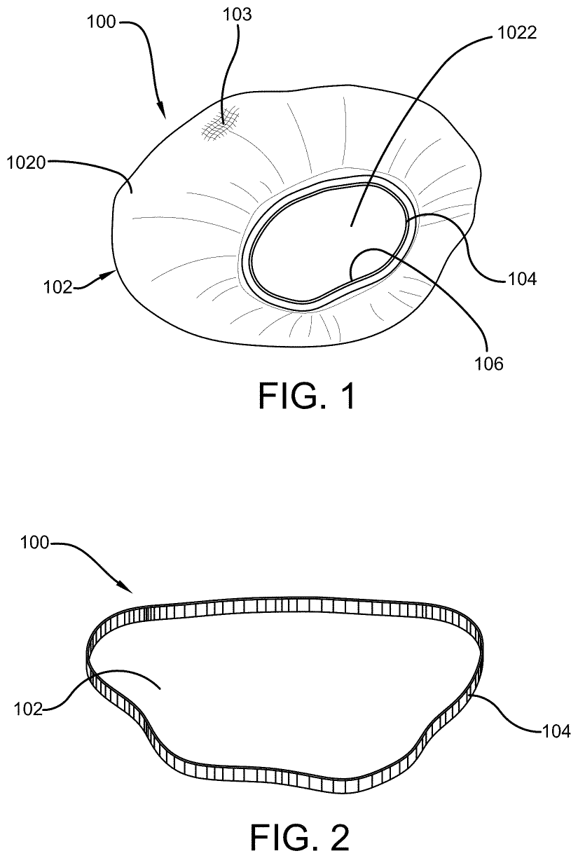

Referring initially to the drawings, FIG. 1 illustrates a perspective view of one potential embodiment of the motorcycle fairing and dash cover 100 of the present invention in accordance with the disclosed architecture, wherein the elastic band 104 is in a relaxed state. More specifically, the motorcycle fairing and dash cover 100 is comprised of a cover portion 102 and an elastic band 104. The cover portion 102 is comprised of an exterior surface 1020, an interior surface 1022 and an opening 106 that defines an interior portion 108 for receipt of a fairing, dashboard and instrument panel of, for example, a motorcycle 300, dirt bike, moped or the like. Nonetheless, the multifunctional motorcycle fairing and dash cover 100 can also be used with motorcycles that do not have a fairing mounted thereto.

The elastic band 104 circumscribes or lines the perimeter of the generally circular or oblong opening 106 around an edge thereof. The fabric material 102 can be stretched by pulling the elastic band 104 from one side of the motorbike dash to another opposing side of the motorbike dash, as explained more fully below. It is also to be appreciated that the elastic band 104 can be stretched to enlarge the size of the opening 106 so that the motorcycle fairing and dash cover 100 can be easily installed and removed from the motorcycle's fairing (if applicable), dashboard and instrument cluster to protect the same from inclement weather (e.g., snow, sleet, rain, wind), debris and harmful UV rays from the sun.

The cover portion 101 of the motorcycle fairing and dash cover 100 can be manufactured from a canvas, vinyl or any other suitable and a durable weatherproof material. The cover portion 101 can further be decorated with an embroidery and/or dye sublimation and have one or more coatings 103 applied to its exterior or interior surfaces 1020, 1022. More specifically, the coatings may be one or more of a waterproof coating, a UV blocking or reflective coating, an antimicrobial agent such as Microban®, or any other coating that not only protects the motorcycle fairing and dash cover 100, thereby prolonging its useful life and its aesthetic appearance, but also the fairing, controls and components positioned in the interior portion 108.

The dash cover 100 can be stretched around the outer perimeter of the fairing, dashboard or other controls during mounting. After the initial stretching, the cover 100 contracts to match the actual area and contours of the fairing dashboard, instrument cluster, etc. covered thereby. The elastic band 104, in turn, contracts to form a tight mounting arrangement with the inner perimeter of the fairing, dashboard, etc. After mounting, a majority of the cover 100 generally lays in a flat orientation across the fairing, dashboard and instrument cluster.

Accordingly, it should be appreciated that the dash cover 100 of the present embodiment can expand from a first unstretched area size to a second stretched area size. In a preferred embodiment, the second area size can be at least 150% (i.e., 1.5 times) that of the first area size. In another embodiment, the second area size can be approximately 200% (i.e., 2 times) that of the first area size. In still yet another embodiment, the second area size can be 300% (i.e., 3 times) of the first area size. The stretchable fabric, accompanied by the respective contraction after mounting, enables the cover 100 to fit various sizes of motorcycle fairings, dashboards and instrument clusters. This flexibility if further expanded upon by the fact that the dash cover 100 may be manufactured in any number of different sizes and shapes. In one embodiment, the dash cover 100 is commercially available for Honda®, BMW®, Harley-Davidson®, Indian®, Yamaha® and Kawasaki® bikes. Also, the dash cover 100 is available for a variety of other motorized vehicles such as, but not limited to, race bikes, sport bikes, touring bikes, etc.

The circumscribed opening 106 has a relatively small diameter in comparison to the overall dimensions of the cover portion 102, and the elastic band 104 contracts the generally circular or oblong edge of the opening 106. The cover portion 102 can be constructed of a relatively lightweight material in a select one or more of a multitude of different colors to match the different styles and color schemes of bikes. The material of the cover portion 102 may also have a knit weave pattern, and may include a glossy, semi-glossy or matte-like finish. The majority of the stretching of the fabric of the dash cover 100 occurs during installation of the same and primarily around the outer perimeter of the cover portion 102. After the initial stretching around the outer periphery, the dash cover 100 contracts to a size to match the dimensions of the dashboard and instrument cluster. Thus, it should be appreciated that the dash cover 100 transforms from an unstretched condition before mounting, to a second maximum stretch condition during mounting, and then to a third less than maximum stretching condition after installation.

The present invention, in one exemplary embodiment, is a protective cover 100 that can fit a multitude of specific bike dashboards, and that includes an adjustable receiving area or opening 106 for enveloping associated protruding sections or instruments of the motorcycle fairing, dash, etc. The dash cover 100 conforms to the shape and size of the components that it envelops, and can be easily mounted on the same by engaging the elastic band 104 with the peripheral edges or sides, i.e. inner perimeter, of the dash. The dash cover 100 can have any variety of logos or trademarks 109 imprinted on the exterior surface 1020 of the cover portion 102, and the cover portion 102 is machine washable. The material of the cover portion 102 is manufactured to not only withstand the outdoor elements, but also to withstand repeated washings. The dash cover 100 is designed to last several years, through thousands of mounting and dismounting cycles, and the interior surface 1022 preferably exhibits non-skidding properties.

FIG. 2 illustrates a perspective view of one potential embodiment of the motorcycle fairing and dash cover 100 of the present invention in accordance with the disclosed architecture, wherein the elastic band 104 is in a stretched state so as to be installed on a motorcycle 300. As shown, the cover portion 102 is stretched by pulling the elastic band 104 from at least two points along the perimeter edge of the opening 106. In the stretched form, the dash cover 100 can be initially expanded to a size larger than the fairing, dashboard, etc. that it is meant to encompass during installation, and then subsequently contract to conform to the shape and contours of the fairing, dashboard, instrument panel, etc. The dash cover 100 can also be shaped and dimensioned in accordance with the fairing, dash, instrument panel design of any particular brand of motorcycle 300. In the storage or unstretched form, the dash cover 100 can have a symmetrical or non-symmetrical shape when the elastic band 104 is in its normal unstretched state. The elastic band 104 provides flexibility to secure the dash cover 100 over the front of the dashboard and instrument cluster area of a motorcycle.

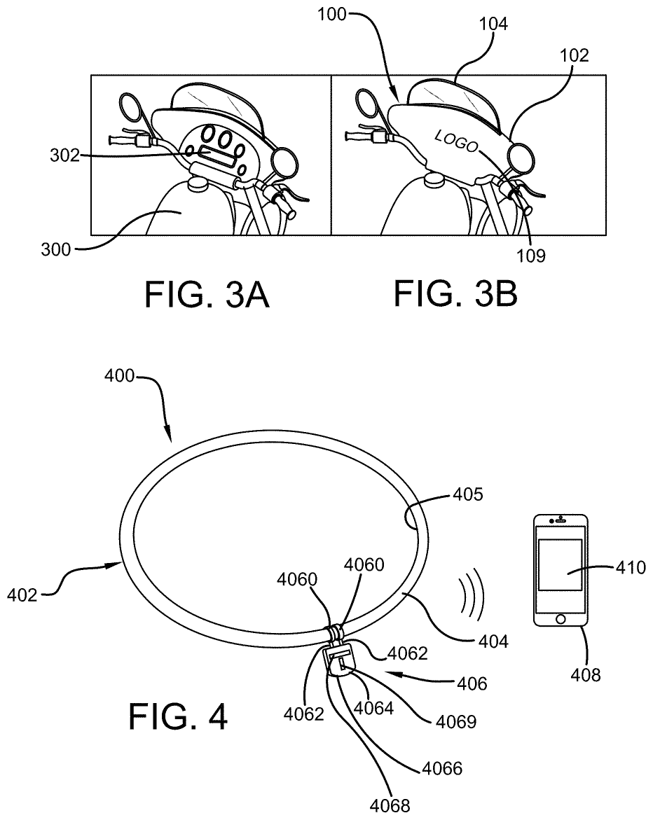

FIG. 3A illustrates a partial perspective view of a prior art motorcycle 300 having a dashboard 302 and instrument cluster, and FIG. 3B illustrates a perspective view of one potential embodiment of the motorcycle fairing and dash cover 100 of the present invention in accordance with the disclosed architecture, wherein the cover 100 is installed on the motorcycle 300 of FIG. 3A. As shown in FIG. 3B, one potential embodiment of the dash cover 100 of the present invention is stretched over the dashboard and instrument cluster 302 of the motorcycle 300 to protect the same from the sun's harmful UV rays, debris, tampering and inclement weather (e.g., rain, sleet, snow, etc.) when not in use. The elastic band 104 of the dash cover 100 is stretched to cover the peripheral edges of the dashboard 302. In one alternative embodiment, an adhesive tape that is safe to use with motorcycle paint (not shown) can be used to secure the dash cover 100 around the peripheral edges of the dashboard 302.

It should be appreciated that the elastic band 104 includes enough flexibility to conform to a multitude of different dash designs and dimensions for a secure fit over and around the dashboard 302. Further, after removing the dash cover 100 from the dash 302, the material of the cover portion 102 and the elastic band 104 contract to their original unstretched shape due to the elasticity of the same. In other illustrative examples, the cover portion 102 can be either translucent or opaque.

FIG. 4 illustrates a perspective view of one potential alternative embodiment of the motorcycle fairing and dash cover 400 of the present invention in accordance with the disclosed architecture. As shown, the dash cover 400 of this embodiment is large enough to cover both the dashboard and front fairing of a motorcycle, and is comprised of a cover portion 402, an elastic band 404 positioned around the perimeter of an opening 405, and a locking mechanism 406. The cover portion 402 is similar to the cover portion 102 described above in terms of functionality, coatings, shape, etc., and also comprises an exterior surface (not shown) and an interior surface 4020. The dashboard and front fairing cover 400 may be generally circular, oval, or any other geometrical or non-geometrical shape to fit and secure around the dashboard and front fairing of a motorcycle. The material of the cover 400 clings to the front surface of the fairing and the dashboard for complete protection from UV rays, rain, snow, sleet and other debris. Further, the dimensions of the cover 400 can also be configured to enclose a headlamp and a pair of turn signals connected to the fairing or instrument panel. For a secure fit, the elasticity of the elastic band 404 can be configured as well to secure over the edges of the headlamp, turn signals or lights, and the dashboard.

The locking mechanism 406 is preferably positioned along the perimeter of the opening 405 and may comprise a pair of locking extensions 4060, each one attached to the elastic band 404 or the cover material 402. Each of the locking extensions 4060 may further comprise an opening 4062 therein such that they can be interlocked together with a lock 4064, as best shown in FIG. 4. When interlocked, the locking mechanism 406 prohibits the cover 400 from expanding, and therefore cannot be removed from the motorcycle.

The lock 4064 can be any mechanical, electrical or biometric lock known in the art. In one embodiment, the lock 4064 may further comprise an alarm 4066, a battery 4068 and a wireless communication module 4069 that can communicate with a mobile application 410 installed on a remote electronic device 408, such as a smartphone, computer, smart watch, tablet or the like. In this manner, an owner may remotely monitor the status of the locking mechanism 406 and be able to determine whether or not the same has been tampered with, in which event the alarm 4066 will sound. Both the alarm 4066 and the wireless communication module 4069 are powered by the battery 4068, which may be a disposable battery or a rechargeable battery.

FIG. 5 illustrates a perspective view of the motorcycle fairing and dash cover 400 of the present invention in accordance with the disclosed architecture, wherein the cover 400 is installed on the motorcycle 300 of FIG. 3A and also covers the fairing of the motorcycle 300. As shown, the front fairing, including the headlamp and turn signals/lights, are completely covered by the dashboard and front fairing cover 400, wherein the elastic band 404 secures to the edges of the front fairing, headlamp, turn lights, etc. It is to be appreciated that the cover 400 can include specific contours and areas for surrounding the headlamp, side lamps, turn signals, or other related instruments on or connected to the dashboard and fairing. The mask 400 also covers all the gauges and radio on the interior side of the fairing. The elastic band 404 forms a skeletal outline and snugly fits around the fairing members for fitted retention to same.

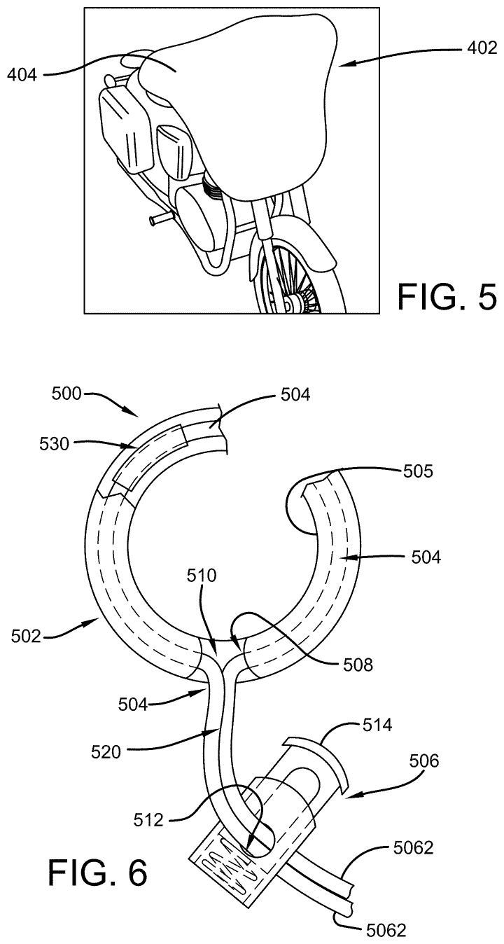

FIG. 6 illustrates a perspective view of yet another potential alternative embodiment of the motorcycle fairing and dash cover 500 of the present invention in accordance with the disclosed architecture. As shown, the dash cover 500 of this embodiment is large enough to cover both the dashboard and front fairing of a motorcycle, and is comprised of a cover portion 502, an elastic cord 504 positioned around the perimeter of an opening 505, and a securement mechanism 506. The cover portion 502 is similar to the cover portion 102 described above in terms of functionality, coatings, shape, etc., and also comprises an exterior surface (not shown) and an interior surface. The dashboard and front fairing cover 500 may be generally circular, oval, or any other geometrical or non-geometrical shape to fit and secure around the dashboard and front fairing of a motorcycle. The material of the cover 500 clings to the front surface of the fairing and the dashboard for complete protection from UV rays, rain, snow, sleet and other debris. Further, the dimensions of the cover 500 can also be configured to enclose a headlamp and a pair of turn signals connected to the fairing or instrument panel. For a secure fit, the elasticity of the elastic cord 504 can be configured as well to secure over the edges of the headlamp, turn signals or lights, and the dashboard. It is to be appreciated that the elastic cord 504 can be mounted and retained within a sleeve 508 circumscribing the opening of the cover 502. The cord 504 can be secured with the retention mechanism 506 (i.e. a spring cord lock). The elastic cord 504 can be pulled to constrict the cover opening 505 and the cord lock 506 can then be engaged to secure the cord 504 in the constricted position, similar to the operation of locking mechanism 406 above, albeit with the inclusion of a cord 504. The elastic cord 504 and spring cord lock 506 constrict the cover opening 505 around the inner perimeter of the fairing to retain the cover 500 to the fairing. The sleeve 508 can further comprise an opening 510 for passing two terminal ends 5062 of the elastic cord 504 therethrough. The terminal ends 5062 can, in turn, pass through an opening 512 in the cord lock 506. A spring-activated tab 514 can be engaged to limit further extension or contraction of the elastic cord 504. The opening 510 in the sleeve 508, accompanied by the elastic cord 504 and cord lock 506, creates a loop 520. The loop 520 can provide for a further attachment mechanism for securing around one or more instrument components. The attachment mechanism can further include a plurality of magnets 530 intermittently spaced and secured within the sleeve 508. The magnets 530 can provide a complimentary retention mechanism for the elastic band or cord 504. The magnets 530 will be attracted to the steel components of the instrument cluster to assist with retaining the cover 500 to the contours of the dash and fairing. It is to be appreciated that other fastener mechanisms can be incorporated into the cover to secure the same to the fairing and other connected components. The other fastener or attachment mechanisms can include one or more of the following: a snap, a button, and a hook and loop connection.

The dash cover 100 and the dashboard and front fairing covers 400, 500 of the present invention can be used for advertising purpose and advertisers can apply their logos and brand names 109 thereon. In one arrangement, the fabric stretch can be uniform in all directions. In another arrangement, the fabric stretch of the cover can be non-uniform. The cover, having an elastic retention band, comprises a one-piece architecture with no requirement of assembling and disassembling. The covers 100, 400, 500 of the present invention can be accompanied with a carry bag for easy storage and carrying.

The elastic covers 100, 400, 500 can also be made of velvet stretch cloth material having strong elasticity to take the shape of the fairing and dashboard. The covers 100, 400, 500 can be wrinkle resistant, and dimensionally stable for effective wrapping of the covers 100, 400, 500 about the fairing. The elastic peripheral bands 104, 404, 504 provide enough retention force to withstand strong winds blowing across the dash and instrument cluster.

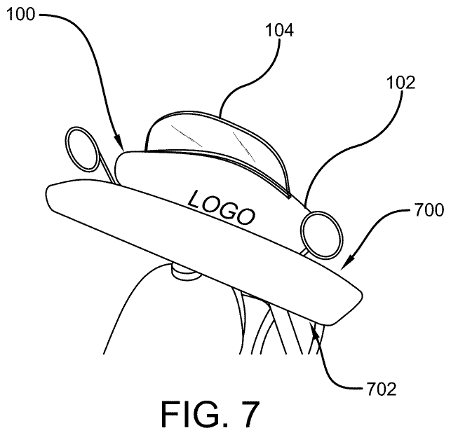

FIG. 7 illustrates a perspective view of one potential embodiment of the motorcycle fairing and dash cover 100 of the present invention and a second accessory cover 700 in accordance with the disclosed architecture, wherein the covers 100, 700 are installed on the motorcycle of FIG. 3A. More specifically, second cover 700 substantially similar to cover 100 and comprises an opening 702 therein. However, cover 700 is meant to extend across and cover the handle bars of the motorcycle. It is to be appreciated that similar type fastener mechanisms to those described above can be incorporated into the cover 700 to secure the same to itself of the handle bars.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “motorbike dash weatherproof cover”, “dash cover”, “covers”, and “elastic covers” are interchangeable and refer to the motorcycle fairing and dash covers 100, 400, 500 of the present invention. Similarly, as used herein “dashboard and front fairing cover”, “dashboard and front fairing mask”, “cover”, and “elastic cover” are interchangeable and refer to the dashboard and front fairing covers 100, 400, 500 of the present invention.

Notwithstanding the forgoing, the motorcycle dash cover 100 and the dashboard and front fairing covers 400, 500 and their various components of the present invention can be of any suitable size and configuration as is known in the art without affecting the overall concept of the invention, provided that it accomplishes the above-stated objectives. One of ordinary skill in the art will appreciate that the size, configuration and material of the covers 100, 400, 500 as shown in the FIGS. are for illustrative purposes only, and that many other sizes and shapes of the covers 100, 400, 500 are well within the scope of the present disclosure. Although the dimensions of the covers 100, 400, 500 are important design parameters for user convenience, the covers 100, 400, 500 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A protective cover for a portion of a motorcycle, the protective cover comprising:
a cover portion comprised of an exterior surface, an interior surface and an opening have a perimeter; and
an elastic band positioned along the perimeter, wherein the cover portion is expandable from a first area size to a second area size and further wherein the second area size is at least 1.5 times said first area size.

2. The protective cover of claim 1, wherein said second area size is at least 2 times said first area size.

3. The protective cover of claim 1, wherein said second area size is at least 3 times said first area size

4. The protective cover of claim 3, wherein said cover portion is waterproof.

5. The protective cover of claim 4, wherein said protective cover is washable.

6. The protective cover of claim 1 further comprising a locking mechanism.

7. The protective cover of claim 6, wherein the locking mechanism prohibits an unauthorized removal of the protective cover from the portion of the motorcycle.

8. The protective cover of claim 6, wherein the locking mechanism comprises a pair of locking extensions, wherein each of the locking extensions has a continuous opening therein for receipt of a lock.

9. The protective cover of claim 8, wherein the locking mechanism comprises the lock, a battery, an alarm and a wireless communication module.

10. The protective cover of claim 9, wherein the wireless communication module is powered by the battery and is in a wireless communication with a remote mobile application.

11. The protective cover of claim 6, wherein the cover portion further comprises a protective coating.

12. The protective cover of claim 11, wherein the protective coating is at least one of a UV coating, a waterproof coating and an anti-microbial coating.

13. A protective cover system for a portion of a motorcycle, the protective cover system comprising:
a cover portion that is expandable from a first area size to a second area size, wherein the second area size extends around an outer perimeter of the portion of the motorcycle;
an attachment mechanism circumscribing a perimeter of an opening in the cover portion; and
a spring cord lock, wherein the attachment mechanism and the spring cord lock prohibit the protective cover from being removed from the portion of the motorcycle.

14. The protective cover system of claim 13, wherein said attachment mechanism is an elastic cord having two terminal ends and a sleeve, and further wherein the two terminal ends pass through said cord lock and are retained by a spring therein.

15. The protective cover system of claim 14, wherein said attachment mechanism further comprises a plurality of magnets intermittently spaced and secured within said sleeve.

16. The protective cover system of claim 15, wherein the cover portion further comprises a protective coating.

17. The protective cover system of claim 16 further comprising a second cover for covering a handle bar portion of the motorcycle, wherein the protective coating is at least one of a UV coating, a waterproof coating and an anti-microbial coating.

18. A method of protecting a fairing and instrument cluster of a vehicle, said method comprising:
providing a weatherproof cover expandable from a first area size to a second area size, wherein the weatherproof cover comprises an elastic attachment mechanism circumscribing an expandable cover opening;
stretching said expandable cover opening over the fairing and instrument cluster;
expanding said weatherproof cover from said first area size to said second area size around an outer perimeter of the fairing and instrument cluster; and
securing said elastic attachment mechanism to an inner perimeter of the fairing.

19. The method of claim 18, wherein said elastic attachment mechanism further comprises a sleeve for retention of an elastic cord and said sleeve comprises an opening for passing two terminal ends of said elastic cord therethrough, and further wherein said two terminal ends pass through a cord lock and are retained by a spring contained therein.

20. The method of claim 19 further comprising the step of pulling said two terminal ends through said cord lock to tighten said elastic attachment mechanism to said inner perimeter of the fairing.
